(19) United States
(12) Patent Application Publication
(10) Pub. No.: US 2004/0261493 A1
(43) Pub. Date: Dec. 30, 2004

(54) Adjustable cushioning device for impact tester

(76) Inventor: Kun Ta Lee, Chong Ho City (TW)

Correspondence Address: Kun Ta Lee, P.O. Box 10-69, Chong Ho, Taipei, 235, TW

(21) Appl. No.: 10/608,393

(22) Filed: Jun. 25, 2003

(51) Int. Cl. G01N 3/00; G01N 3/303

(52) U.S. Cl. 73/12.09

(57) ABSTRACT

An adjustable cushioning device includes a seat to be supported in an impact testing machine and having an outer thread, a pad disposed on the seat, and a housing having a chamber to slidably receive the pad and having an inner thread to thread with the outer thread of the seat, and to adjust the housing up and down relative to the seat when the housing is rotated relative to the seat. The housing is adjustable up and down relative to the seat to adjust a height of an exposing portion of the pad that is exposable upwardly beyond the housing, to sustain different forces that may be applied onto the pad of the cushioning device.

### BACKGROUND OF THE INVENTION

1. Field of the Invention

The present invention relates to a cushioning device, and more particularly to an adjustable cushioning device for impact tester or impact testing machines.

2. Description of the Prior Art

Typical impact testers or impact testing machines may comprise a slidable table slidably supported above a platform, and movable downwardly toward the platform, for testing purposes, and a cushioning device disposed on the platform, to cushion the downward movement or the impact of the slidable table against the platform and/or the cushioning device.

The typical impact testers or impact testing machines may further comprise a sensing or detecting device to detect the striking or impact waves generated by the impact of the slidable table against the platform and/or the cushioning device.

For testing different materials or objects, weight members of different weights may be disposed or supported on the slidable table, and different striking or impact waves may be generated when the slidable table strikes or impacts against the platform and/or the cushioning device.

However, when the weight members of different weights are selectively or changeably disposed or supported on the slidable table, different cushioning devices are required to be changed and disposed or supported on the platform, to cushion the downward movement or the impact of the slidable table against the platform and/or the cushioning device.

Accordingly, a number of cushioning devices are required to be changed and disposed or supported on the platform frequently by the users or workers, in order to test different materials or objects of different weights. It may take a lot of time to change the cushioning devices, and it may take a large space to receive or store the cushioning devices.

The present invention has arisen to mitigate and/or obviate the afore-described disadvantages of the conventional cushioning devices.

### SUMMARY OF THE INVENTION

The primary objective of the present invention is to provide an adjustable cushioning device for impact tester or impact testing machines, and for allowing the adjustable cushioning device to be easily and quickly changed to different thicknesses.

In accordance with one aspect of the invention, there is provided an adjustable cushioning device for an impact testing machine, the cushioning device comprising a seat to be supported in the impact testing machine, the seat including an outer thread formed in an outer peripheral portion thereof, a pad disposed on the seat, and a housing including a chamber formed therein to slidably receive the pad, and including an inner thread to thread with the outer thread of the seat, and to adjust the housing up and down relative to the seat when the housing is rotated relative to the seat. The housing is adjustable up and down relative to the seat to adjust a height of an exposing portion of the pad that exposable upwardly beyond the housing, and thus to sustain different forces that may be applied onto the pad of the cushioning device.

A device may further be provided for limiting a movement of the housing relative to the seat, and includes a block secured on top of the seat, the block includes a peripheral rib extended radially outward therefrom and extended radially and outwardly beyond the seat, to engage with the housing and to limit the movement of the housing relative to the seat.

One or more pins may further be provided and engaged between the block and the seat, to prevent the block from being rotated relative to the seat. The seat includes at least one step hole formed therein to partially receive the at least one pin, and the at least one pin includes a peripheral swelling received in the at least one step hole of the seat.

The housing includes a peripheral flange extended radially into the chamber thereof, and engageable with the peripheral rib of the block, and to limit the movement of the housing relative to the seat.

A base may further be provided, and a fastener may secure the block and the seat and the base together. The base includes a center hole formed therein, the seat includes a bore formed therein and aligned with the center hole of the base to receive the fastener, and the block includes a screw hole formed therein to thread with the fastener, and to secure the block and the seat and the base together.

The base includes a depression formed therein, the seat includes a lower portion received in the depression of the base, to prevent the seat from being moved laterally and radially relative to the base.

A ferrule may further be provided and secured on top of the housing, for facilitating a rotation of the housing relative to the seat.

A positioning device may further be provided for positioning the housing to the seat. The positioning device includes at least one spring biased detent received in the housing, and engageable with the seat, to position the housing to the seat.

The housing includes at least one lateral passage formed therein to slidably receive the detent, the positioning device further includes a spring received in the at least one lateral passage of the housing and engaged with the detent, to bias the detent to engage with the seat.

The housing includes a screw threaded to the at least one lateral passage thereof, to retain the spring and the detent in the at least one lateral passage thereof.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an impact tester or impact testing machine having an adjustable cushioning device in accordance with the present invention;

FIG. 2 is a perspective view of the impact tester or impact testing machine, similar to FIG. 1, illustrating the operation of the impact tester or impact testing machine;

FIG. 3 is an exploded view of the adjustable cushioning device;

FIG. 4 is a partial exploded view of the adjustable cushioning device;

FIG. 5 is a perspective view of the adjustable cushioning device;

FIG. 6 is a cross sectional view taken along lines 6-6 of FIG. 5; and

FIG. 7 is a cross sectional view similar to FIG. 6, illustrating the operation of the adjustable cushioning device.

### DETAILED DESCRIPTION OF THE PREFERRED EMBODIMENT

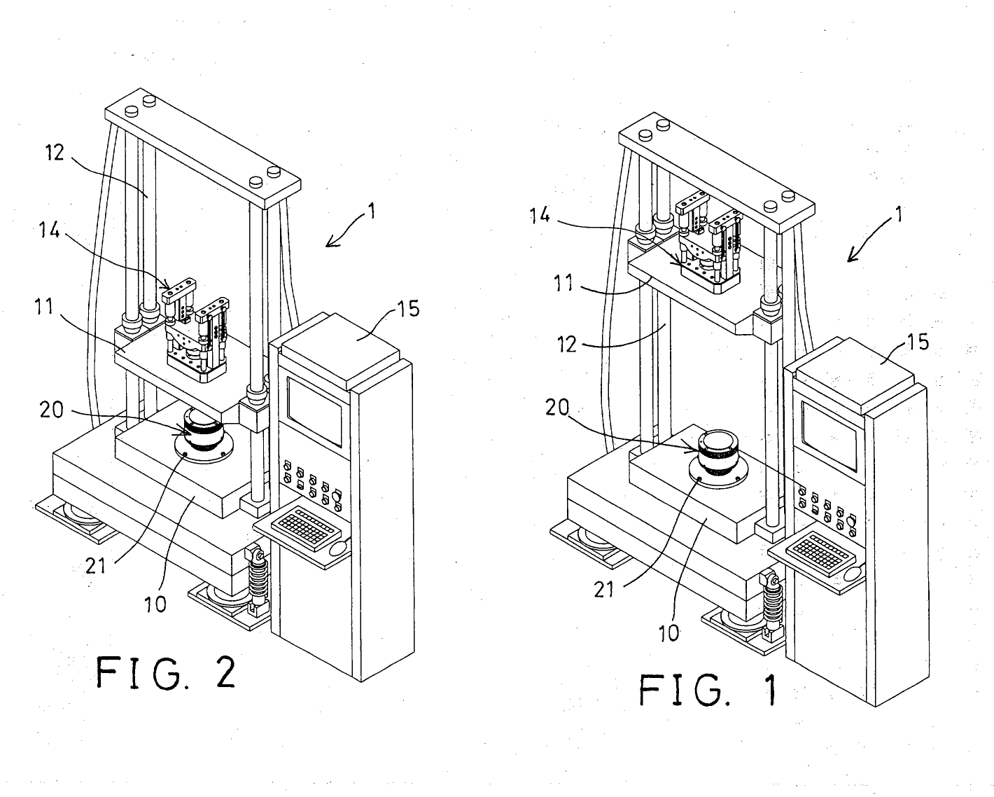

Referring to the drawings, and initially to FIGS. 1 and 2, illustrated is an impact tester or impact testing machine 1 which comprises a slidable table 11 slidably supported above a platform 10 by one or more posts 12, and movable downwardly toward the platform 10, for testing purposes. For example, the slidable table 11 may be used to support the materials or objects to be tested, or to support the other supporting devices 14 that may be used to support materials or objects of different weights.

The impact tester or impact testing machine 1 may further comprises a computerized sensing or detecting device 15 to detect the striking or impact or shock waves generated by the impact of the slidable table 11 against the platform 10. The supporting devices 14 and the computerized sensing or detecting device 15 of the impact tester or impact testing machine 1 are not related to the present invention and will not be described in further details.

An adjustable cushioning device 20 in accordance with the present invention is provided for being disposed on the platform 10, to cushion the downward movement or the impact of the slidable table 11 against the platform 10 and/or the cushioning device 20, and/or to rebound the slidable table 11.

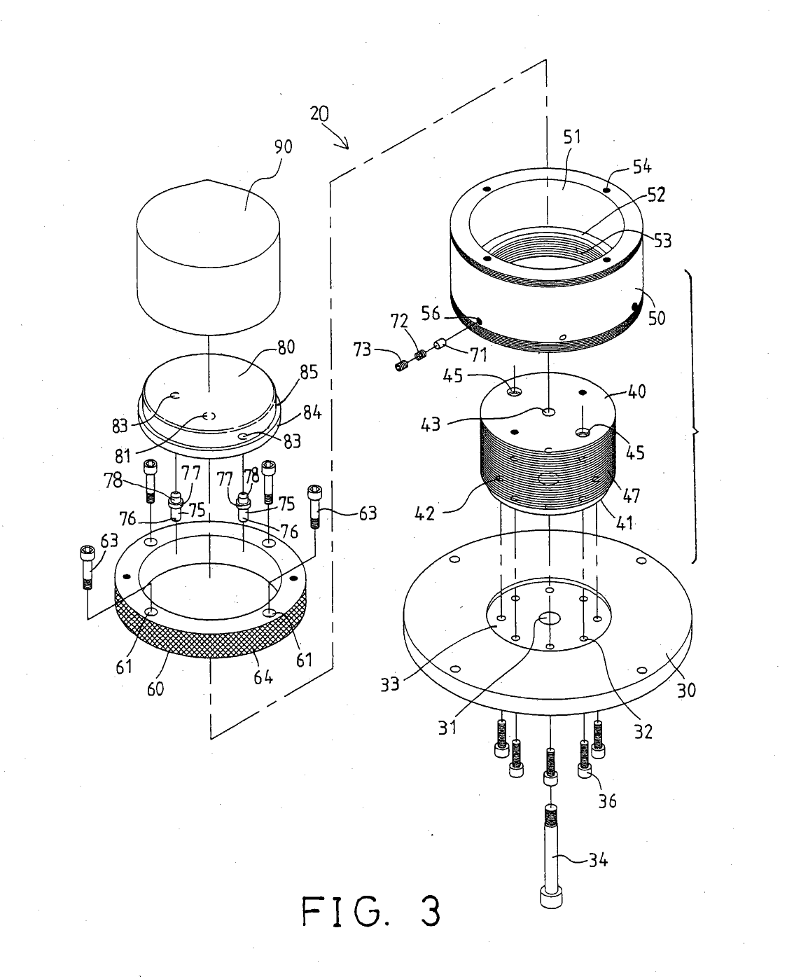

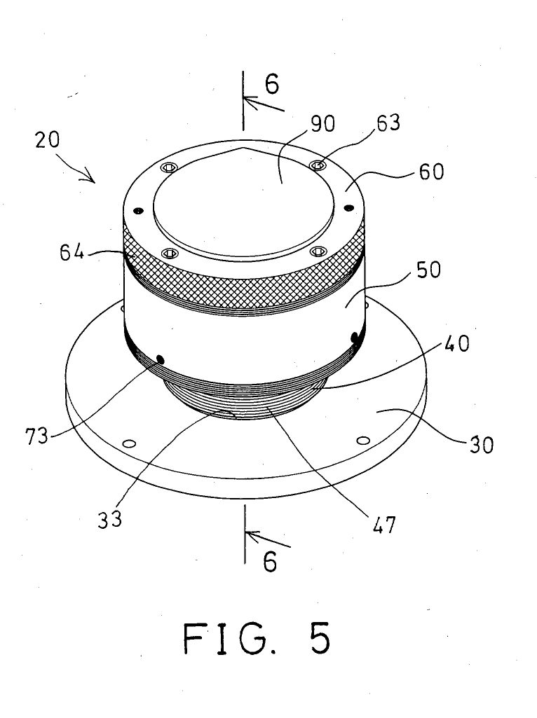

As shown in FIGS. 3-6, the adjustable cushioning device 20 comprises a base 30 to be supported and secured onto the platform 10 with such as fasteners 21 (FIGS. 1, 2). The base 30 includes a center hole 31 and a number of orifices 32 formed around the center hole 31 to receive fasteners 34, 36 respectively, and a depression 33 formed in the upper portion thereof, and communicating with the center hole 31 and the orifices 32 thereof.

A seat 40 includes a lower portion 41 received or engaged in the depression 33 of the base 30, to prevent the seat 40 from moving laterally or radially relative to the base 30, and includes a number of screw holes 42 formed in the bottom thereof and aligned with the orifices 32 of the base 30, to thread with the fasteners 36, which may secure the seat 40 on the base 30.

The seat 40 further includes a bore 43 formed in the center portion thereof, and aligned with the center hole 31 of the base 30, to slidably receive the fastener 34, and to allow the fastener 34 to extend upwardly beyond the seat 40. The seat 40 further includes one or more, such as two step holes 45 formed in the upper portion thereof, and includes an outer thread 47 formed in the outer peripheral portion thereof.

A cylindrical housing 50 includes a chamber 51 formed therein, and includes a peripheral flange 52 extended radially into the bottom portion of the chamber 51 of the housing 50, and includes an inner thread 53 formed therein, such as formed in the inner peripheral portion of the peripheral flange 52 thereof for threading with the outer thread 47 of the seat 40, to allow the housing 50 to be adjusted up and down relative to the seat 40 by rotating the housing 50 relative to the seat 40.

A ring-shaped ferrule 60 may further be provided and disposed onto the housing 50, and includes one or more orifices 61 formed therein to receive fasteners 63 which may be threaded to screw holes 54 that are formed in the upper portion of the housing 50, to secure the ferrule 60 on top of the housing 50. The ferrule 60 preferably includes a knurled outer surface 64 formed thereon for allowing the ferrule 60 and thus the housing 50 to be easily rotated by the users.

The housing 50 includes one or more lateral passages 56 formed in the lower peripheral portion thereof, each to receive a detent 71 and a spring 72 therein, and a screw or fastener 73 is threaded to the respective lateral passage 56, to retain the detent 71 and the spring 72 in the respective lateral passage 56. The springs 72 may force or bias the detents 71 to engage with the seat 40, and to form a positioning device to position the housing 50 to the seat 40 at the selected or adjusted position.

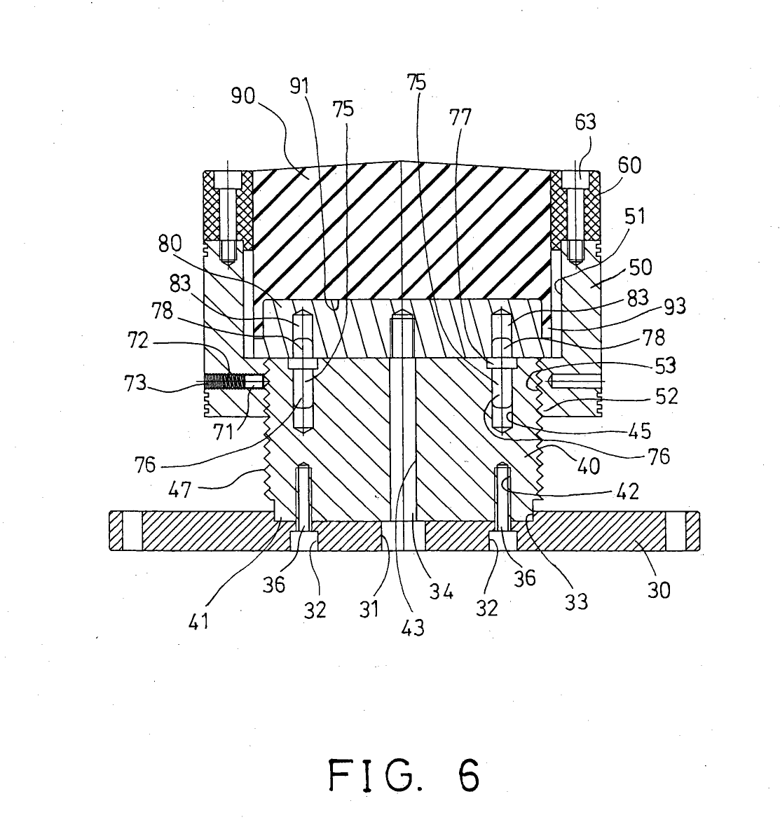

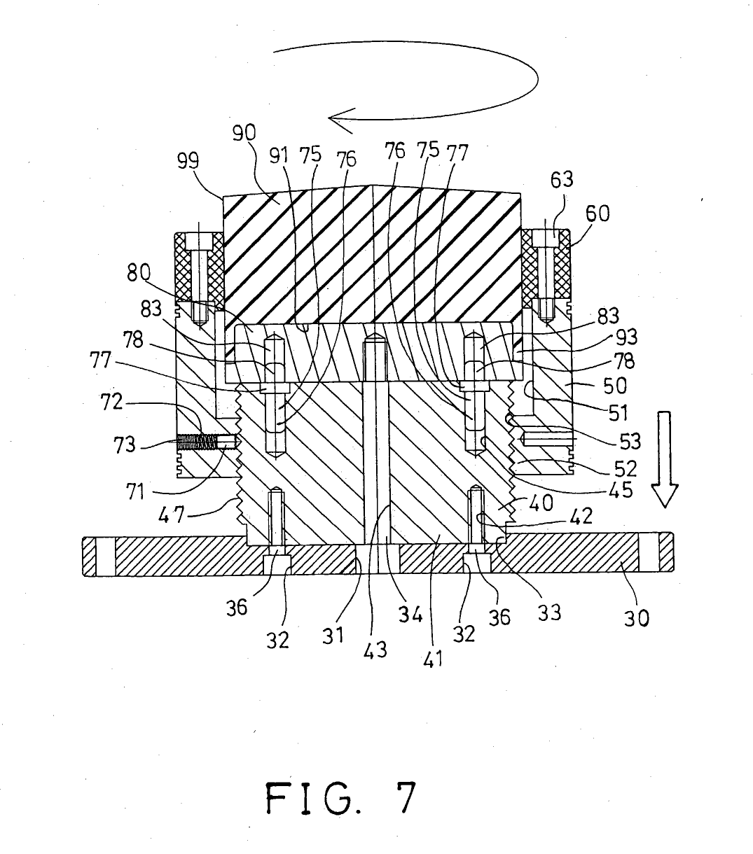

One or more, such as two anchor studs or pins 75 may further be provided and each may include a lower portion 76 slidably received in the step holes 45 of the seat 40, and each may include a peripheral swelling 77 extended radially out from the middle portion and seated within the step holes 45 of the seat 40 (FIGS. 6, 7), to position the pins 75 on top of the seat 40. Each of the pins 75 has an upper portion 78 extended upwardly beyond the seat 40.

A block 80 is received in the chamber 51 of the housing 50, and engaged onto the seat 40, and includes a screw hole 81 formed in the bottom thereof, to thread with the fastener 34 which may secure the block 80 on top of the seat 40. The block 80 further includes one or more, such as two cavities 83 formed in the bottom thereof, to receive the upper portions 78 of the pins 75, and to anchor the block 80 to the seat 40, and to prevent the block 80 from being rotated relative to the seat 40.

The block 80 includes a peripheral rib 84 extended radially outward from the bottom portion thereof, to form or define a peripheral shoulder 85 in the outer peripheral portion thereof. The peripheral rib 84 of the block 80 is extended radially and outwardly of the seat 40, to engage with the peripheral flange 52 of the housing 50 (FIG. 6), and to limit the movement of the housing 50 relative to the seat 40. The block 80 may thus be used as a limiting device to prevent the housing 50 from being moved upwardly beyond or disengaged from the seat 40.

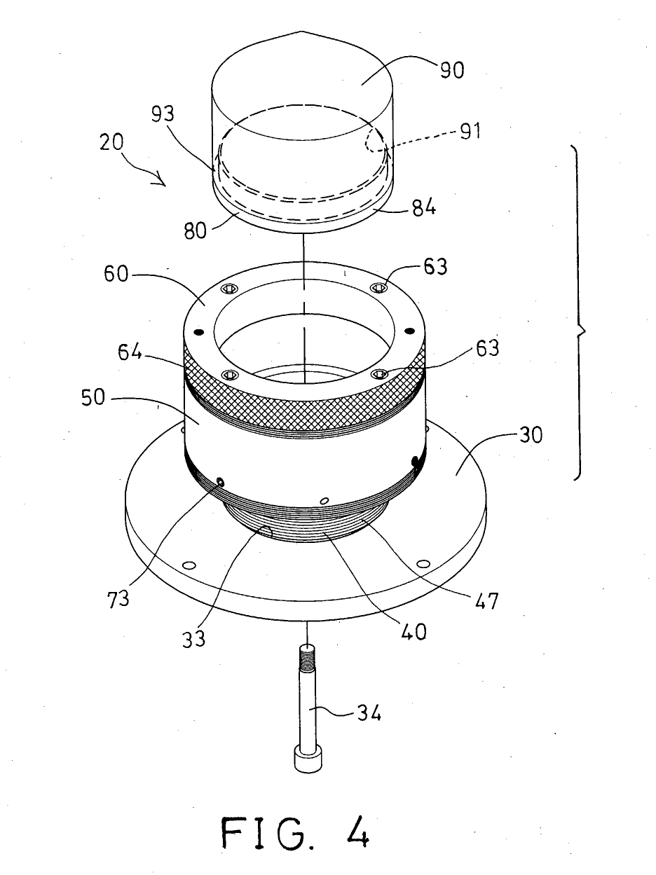

A cushioning pad 90 is disposed on the seat 40 or the block 80, and slidably received in the chamber 51 of the housing 50, and includes a space 91 formed in the bottom portion thereof (FIGS. 4, 6, 7), to partially receive the block 80, and to form or define a peripheral skirt 93 which may be engaged with the peripheral shoulder 85 of the block 80. The block 80 may be engaged in the space 91 of the pad 90 in such as a force-fitted engagement, to retain the pad 90 on top of the block 80.

In operation, as shown in FIGS. 6, 7, the housing 50 may be rotated relative to the seat 40, to adjust the housing 50 up and down relative to the seat 40, and to adjust the height of the exposing portion 99 of the pad 90 (FIG. 7) that may be exposed or extended upwardly beyond the housing 50 or the ferrule 60, in order to sustain different forces that may be applied onto the pad 90 of the cushioning device 20.

It is to be noted that the pad 90 may be directly disposed or supported on the seat 40, instead of being supported on the block 80. The ferrule 60 is optionally secured on top of the housing 50. However, the ferrule 60 may be made of stronger materials, such as steel, to protect the housing 50, and to prevent the housing 50 from being stricken or damaged by objects, such as the slidable table 11.

Accordingly, the adjustable cushioning device in accordance with the present invention is easily and quickly changeable or adjustable to different thicknesses, for allowing the impact tester or impact testing machines to test different materials or objects of different weights.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An adjustable cushioning device for an impact testing machine, said cushioning device comprising:
a seat to be supported in the impact testing machine, said seat including an outer thread formed in an outer peripheral portion thereof,
a pad disposed on said seat, and
a housing including a chamber formed therein to slidably receive said pad, and including an inner thread to thread with said outer thread of said seat, and to adjust said housing up and down relative to said seat when said housing is rotated relative to said seat, and
said housing being adjustable up and down relative to said seat to adjust a height of an exposing portion of said pad that exposable upwardly beyond said housing.

2. The adjustable cushioning device as claimed in claim 1 further comprising means for limiting a movement of said housing relative to said seat.

3. The adjustable cushioning device as claimed in claim 2, wherein said limiting means includes a block secured on top of said seat, said block includes a peripheral rib extended radially outward therefrom and extended radially and outwardly beyond said seat, to engage with said housing and to limit the movement of said housing relative to said seat.

4. The adjustable cushioning device as claimed in claim 3 further comprising at least one pin engaged between said block and said seat, to prevent said block from being rotated relative to said seat.

5. The adjustable cushioning device as claimed in claim 4, wherein said seat includes at least one step hole formed therein to partially receive said at least one pin, and said at least one pin includes a peripheral swelling received in said at least one step hole of said seat.

6. The adjustable cushioning device as claimed in claim 3, wherein said housing includes a peripheral flange extended radially into said chamber thereof, and engageable with said peripheral rib of said block, and to limit the movement of said housing relative to said seat.

7. The adjustable cushioning device as claimed in claim 3 further comprising a base, and a fastener securing said block and said seat and said base together.

8. The adjustable cushioning device as claimed in claim 7, wherein said base includes a center hole formed therein, said seat includes a bore formed therein and aligned with said center hole of said base to receive said fastener, and said block includes a screw hole formed therein to thread with said fastener, and to secure said block and said seat and said base together.

9. The adjustable cushioning device as claimed in claim 7, wherein said base includes a depression formed therein, said seat includes a lower portion received in said depression of said base, to prevent said seat from being moved laterally and radially relative to said base.

10. The adjustable cushioning device as claimed in claim 1 further comprising a ferrule secured on top of said housing, for facilitating a rotation of said housing relative to said seat.

11. The adjustable cushioning device as claimed in claim 1 further comprising means for positioning said housing to said seat.

12. The adjustable cushioning device as claimed in claim 11, wherein said positioning means includes at least one spring biased detent received in said housing, and engageable with said seat, to position said housing to said seat.

13. The adjustable cushioning device as claimed in claim 12, wherein said housing includes at least one lateral passage formed therein to slidably receive said detent, said positioning means further includes a spring received in said at least one lateral passage of said housing and engaged with said detent, to bias said detent to engage with said seat.

14. The adjustable cushioning device as claimed in claim 13, wherein said housing includes a screw threaded to said at least one lateral passage thereof, to retain said spring and said detent in said at least one lateral passage thereof.
